(19) United States
(12) Patent Application Publication
(10) Pub. No.: US 2026/0236310 A1
(43) Pub. Date: Aug. 13, 2026

(54) MODEL COMPILING METHOD, APPARATUS, DEVICE, AND STORAGE MEDIUM

(71) Applicant: CLOUD INTELLEIGENCE ASSETS HOLDING (SINGAPORE) PRIVATE LIMITED, Singapore (SG)

(72) Inventors: Zhen ZHENG, Hangzhou, Zhejiang (CN); Donglin ZHUANG, Hangzhou, Zhejiang (CN); Shuaiwen SONG, Hangzhou, Zhejiang (CN); Xiafei QIU, Hangzhou, Zhejiang (CN); Junjie BAI, Hangzhou, Zhejiang (CN); Wei LIN, Hangzhou, Zhejiang (CN)

(21) Appl. No.: 19/168,783

(22) PCT Filed: Apr. 17, 2024
(86) PCT No.: PCT/CN2024/088380

§ 371 Date: Sep. 24, 2025

(30) Foreign Application Priority Data
Apr. 25, 2023 (CN) 202310478439.4

(51) Int. Cl. G06F 9/50; G06F 9/54

(52) U.S. Cl. CPC G06F 9/5038; G06F 9/54

(57) ABSTRACT

The present disclosure provides a model compiling method. The method includes that: a target computation sub-graph in a computation graph corresponding to a model to be compiled is obtained and the target computation sub-graph includes multiple memory-access-intensive operators and data corresponding to the multiple memory-access-intensive operators; multiple groups of computation tasks to be serially executed by a target thread are determined based on multiple threads set in an executor of the model and a computation task parallelism degree of each thread sequential rearrangement is performed on multiple computation tasks contained in the any group of computation tasks, and an execution instruction sequence both corresponding to the target thread and the any group of computation tasks is generated; and an executable program file for executing the model by the executor is determined based on the execution instruction sequence corresponding to the any group of computation tasks.

The present disclosure claims priority of Chinese Patent Application No. 202310478439.4, filed to China National Intellectual Property Administration on Apr. 25, 2023 and titled “MODEL COMPILING METHOD, APPARATUS, DEVICE, AND STORAGE MEDIUM”, the content of which is hereby incorporated by reference in its entirety.

### TECHNICAL FIELD

The present disclosure relates to the field of artificial intelligence technologies, and in particular, to a model compiling method, an apparatus, a device, and a storage medium.

### BACKGROUND OF THE INVENTION

Currently, machine learning is widely applied to fields such as image processing, natural language processing, searching, recommendation, and advertising. A computation task of the machine learning usually needs to consume specific computing power, and is usually deployed on an executor such as a graphics processing unit (GPU) for computation.

In a specific implementation process, model compiling needs to be performed on a machine learning model from high-level modeling to low-level deployment, to be specific, a high-level code language corresponding to the machine learning model is translated into a low-level machine language supported by underlying hardware. During the model compiling, the high-level code language corresponding to the machine learning model is first converted into a computational representation of a computation graph corresponding to the machine learning model, and an optimization policy is performed on the computation graph, to generate the final low-level machine language, for example, an executable program running on the GPU. The optimization policy performed on the computation graph determines task execution efficiency of the machine learning model.

In a related art, when a model compiling result is run, there are usually problems such as large scheduling overheads when a CPU schedules execution instructions corresponding to computation sub-graphs in the computation graph to the GPU, and insufficient resource utilization of the GPU. Consequently, a performance requirement of a user for a machine learning computation task cannot be met.

### SUMMARY OF THE INVENTION

Embodiments of the present disclosure provide a model compiling method, an apparatus, a device, and a storage medium, to improve execution efficiency of an executable program file obtained through compiling when the executable program file is executed by an executor and resource utilization of the executor.

According to a first aspect, some embodiments of the present disclosure provide a model compiling method. The model compiling method includes the following steps. A target computation sub-graph in a computation graph corresponding to a model to be compiled is obtained, where the target computation sub-graph includes multiple memory-access-intensive operators and data corresponding to the multiple memory-access-intensive operators, and the target computation sub-graph is one computation sub-graph contained in the computation graph. Multiple groups of computation tasks to be serially executed by a target thread are determined based on multiple threads set in an executor of the model and a computation task parallelism degree of each thread, where each group of computation tasks includes multiple computation tasks, each computation task is a task for sequentially adopting the multiple memory-access-intensive operators to perform computation on the corresponding data, the computation task parallelism degree indicates a quantity of computation tasks executed by each thread in parallel, and the target thread is any one of the multiple threads. For any group of computation tasks based on computational dependencies of the multiple memory-access-intensive operators, sequential rearrangement is performed on multiple computation tasks contained in the any group of computation tasks, to obtain the multiple rearranged computation tasks, where the rearrangement enables different computation tasks corresponding to the same memory-access-intensive operator to be arranged in parallel. An execution instruction sequence both corresponding to the target thread and the any group of computation tasks is generated based on the multiple rearranged computation tasks. An executable program file for executing the model by the executor is determined based on the execution instruction sequence both corresponding to the target thread and the any group of computation tasks, where the executable program file includes execution instruction sequences respectively corresponding to multiple computation sub-graphs contained in the computation graph.

According to a second aspect, some embodiments of the present disclosure provide a model compiling apparatus. The model compiling apparatus includes: an obtaining module, configured to obtain a target computation sub-graph in a computation graph corresponding to a model to be compiled, where the target computation sub-graph includes multiple memory-access-intensive operators and data corresponding to the multiple memory-access-intensive operators, and the target computation sub-graph is one computation sub-graph contained in the computation graph; and a compiling module, configured to: determine, based on multiple threads set in an executor of the model and a computation task parallelism degree of each thread, multiple groups of computation tasks to be serially executed by a target thread, where each group of computation tasks includes multiple computation tasks, each computation task is a task for sequentially adopting the multiple memory-access-intensive operators to perform computation on the corresponding data, the computation task parallelism degree indicates a quantity of computation tasks executed by each thread in parallel, and the target thread is any one of the multiple threads; perform, for any group of computation tasks based on computational dependencies of the multiple memory-access-intensive operators, sequential rearrangement on multiple computation tasks contained in the any group of computation tasks, to obtain the multiple rearranged computation tasks, where the rearrangement enables different computation tasks corresponding to the same memory-access-intensive operator to be arranged in parallel; generate, based on the multiple rearranged computation tasks, an execution instruction sequence both corresponding to the target thread and the any group of computation tasks; and determine, based on the execution instruction sequence both corresponding to the target thread and the any group of computation tasks, an executable program file for executing the model by the executor, where the executable program file includes execution instruction sequences respectively corresponding to multiple computation sub-graphs contained in the computation graph.

According to a third aspect, some embodiments of the present disclosure provide an electronic device, including: a memory, a processor, and a communication interface. The memory stores executable code, and when the executable code is executed by the processor, the processor is enabled to perform the model compiling method according to the first aspect.

According to a fourth aspect, some embodiments of the present disclosure provide a non-transitory machine-readable storage medium. The non-transitory machine-readable storage medium stores executable code, and when the executable code is executed by a processor of an electronic device, the processor is enabled to implement at least the model compiling method according to the first aspect.

### BRIEF DESCRIPTION OF DRAWINGS

To describe the technical solutions in embodiments of the present disclosure more clearly, the following briefly describes the accompanying drawings for describing embodiments. It is clear that the accompanying drawings in the following descriptions show some embodiments of the present disclosure, and a person having ordinary skill in the art may still derive other drawings from these accompanying drawings without creative efforts.

FIG. 1 is a flowchart of a model compiling method according to some embodiments of the present disclosure.

FIG. 2 is a schematic diagram of grouping of computation tasks according to some embodiments of the present disclosure.

FIG. 3 is a flowchart of another model compiling method according to some embodiments of the present disclosure.

FIG. 4 is a schematic diagram of execution situations of execution instruction sequences according to some embodiments of the present disclosure.

FIG. 5 is a flowchart of still another model compiling method according to some embodiments of the present disclosure.

FIG. 6 is a flowchart of still another model compiling method according to some embodiments of the present disclosure.

FIG. 7 is a schematic diagram of computation sub-graphs according to some embodiments of the present disclosure.

FIG. 8 is a structural schematic diagram of a model compiling apparatus according to some embodiments of the present disclosure.

FIG. 9 is a structural schematic diagram of an electronic device according to some embodiments of the present disclosure.

### DETAILED DESCRIPTION OF THE INVENTION

To make objectives, technical solutions, and advantages of embodiments of the present disclosure clearer, the technical solutions in embodiments of the present disclosure are clearly and completely described below with reference to the accompanying drawings in embodiments of the present disclosure. Apparently, the described embodiments are some rather than all of embodiments of the present disclosure. All other embodiments obtained by a person having ordinary skill in the art based on embodiments of the present disclosure without making creative efforts shall fall within the protection scope of the present disclosure.

The following describes implementations of the present disclosure in detail with reference to the accompanying drawings. Embodiments and features in embodiments are mutually combined in a case that no conflict occurs in each embodiment.

In addition, a sequence of steps in the following method embodiments is an example, and is not strictly limited.

It should be noted that, user information (including, but not limited to, user equipment information, user personal information, and the like) and data (including, but not limited to, data for analysis, stored data, displayed data, and the like) involved in embodiments of the present disclosure are both information and data that are authorized by a user or that are sufficiently authorized by all parties, and related data needs to be collected, used, and processed by complying with related laws and regulations and standards in related countries and regions, and a corresponding operation entry is provided for the user to select to authorize or reject.

For ease of understanding, several concepts involved in embodiments of the present disclosure are described first.

Model compiling is a process of converting a machine learning algorithm corresponding to a machine learning model from a development form to a deployment form. The development form of the machine learning algorithm is source code written in a high-level programming language that resembles a natural language and a mathematical formula representation, and the deployment form of the machine learning algorithm is program code executed by an underlying machine. Commonly speaking, the model compiling is a process of converting a high-level code language to a low-level machine language, and is aimed at deploying the machine learning model in a specific hardware environment.

A computation graph is a tool that represents computation logic and a state in an inference process of a machine learning model. A computation graph corresponding to a machine learning model includes multiple computation sub-graphs, and each computation sub-graph includes an operator and data corresponding to the multiple memory-access-intensive operators (usually represented in a tensor form). In a model compiling process, the computation graph is an intermediate representation (IR) of conversion from a high-level code language to a low-level machine language. A corresponding optimization policy is performed on the computation graph, to obtain the final compiled low-level machine language, that is, an executable program file of underlying hardware.

During actual application, operators contained in the computation sub-graphs are classified into a compute-intensive operator and a memory-access-intensive operator according to a ratio of compute instructions to memory access instructions corresponding to each operator in the executable program file. The compute-intensive operator is an operator whose ratio of the compute instructions to the memory access instructions is greater than a specified threshold, for example, matrix multiplication and convolution. The memory-access-intensive operator is an operator whose ratio of the compute instructions to the memory access instructions is less than or equal to the specified threshold, for example, element-wise computation and reduce computation. A model compiling method in the embodiments is used for optimizing an execution instruction compiling process related to the memory-access-intensive operator. In short, in the compute-intensive operator, certain data is repeatedly used for many times. For example, in matrix multiplication, different multiplication computations are performed on a point in a matrix for many times. In the memory-access-intensive operator, certain data is used once. For example, in an element-wise addition computation of two matrices, an addition computation is performed on a point once.

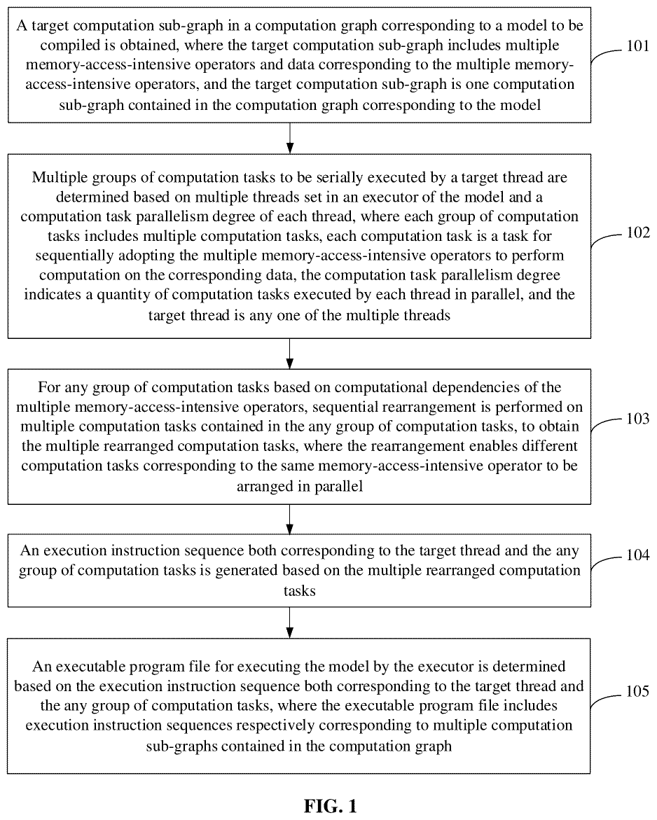

FIG. 1 is a flowchart of a model compiling method according to some embodiments of the present disclosure. As shown in FIG. 1, the method includes the following steps.

In step 101, a target computation sub-graph in a computation graph corresponding to a model to be compiled is obtained, where the target computation sub-graph includes multiple memory-access-intensive operators and data corresponding to the multiple memory-access-intensive operators, and the target computation sub-graph is one computation sub-graph contained in the computation graph corresponding to the model.

In step 102, multiple groups of computation tasks to be serially executed by a target thread are determined based on multiple threads set in an executor of the model and a computation task parallelism degree of each thread, where each group of computation tasks includes multiple computation tasks, each computation task is a task for sequentially adopting the multiple memory-access-intensive operators to perform computation on the corresponding data, the computation task parallelism degree indicates a quantity of computation tasks executed by each thread in parallel, and the target thread is any one of the multiple threads.

In step 103, for any group of computation tasks based on computational dependencies of the multiple memory-access-intensive operators, sequential rearrangement is performed on multiple computation tasks contained in the any group of computation tasks, to obtain the multiple rearranged computation tasks, where the rearrangement enables different computation tasks corresponding to the same memory-access-intensive operator to be arranged in parallel. In step 104, an execution instruction sequence both corresponding to the target thread and the any group of computation tasks is generated based on the multiple rearranged computation tasks.

In step 105, an executable program file for executing the model by the executor is determined based on the execution instruction sequence both corresponding to the target thread and the any group of computation tasks, where the executable program file includes execution instruction sequences respectively corresponding to multiple computation sub-graphs contained in the computation graph.

In the embodiments, the model compiling method is performed by a CPU, and a compiler having a model compiling function is disposed in the CPU. In some implementations, the executor is an accelerator such as a graphics processing unit (GPU). An example in which the executor is the GPU is used below for description, but is not limited thereto.

During actual application, based on a limited on-chip memory (including a shared memory and a register) in the GPU, when the executable program file corresponding to the model is executed, a resource use conflict between a compute-intensive operator and a memory-access-intensive operator in a computation sub-graph usually occurs, resulting in low running efficiency of the executable program corresponding to the model and insufficient use of GPU resources.

Specifically, the compute-intensive operator in the computation sub-graph has data locality. To achieve high data reuse efficiency, a large quantity of on-chip memories in the GPU is usually used to store data computation results, so that these computation results are further accessed by multiple other computations. This feature inevitably results in a small quantity of on-chip memories in the GPU being used by the memory-access-intensive operator. It is understood that a small quantity of on-chip memories in the GPU can provide a small quantity of threads, while the memory-access-intensive operator usually needs a large quantity of threads to improve memory access efficiency of the off-chip memory in the GPU. Therefore, comprehensively speaking, the resource use conflict between the compute-intensive operator and the memory-access-intensive operator lies in that, the limited on-chip memory in the GPU cannot provide sufficient on-chip memories for storing the data computation results for the compute-intensive operator while providing sufficient threads for the memory-access-intensive operator, to achieve a high thread parallelism degree.

To solve at least one of the foregoing technical problems, in the embodiments, sequential rearrangement is performed on computation tasks corresponding to the memory-access-intensive operator in a thread, so that when a quantity of threads in the GPU remains unchanged, and an executable program file obtained through encoding is executed, an overall parallelism degree of the computation tasks corresponding to the memory-access-intensive operator is higher, thereby effectively improving running efficiency of the executable program corresponding to the model. Since the sequential rearrangement of the computation tasks corresponding to the memory-access-intensive operator is manifested as rearrangement of execution instruction sequences corresponding to the computation tasks in the executable program file corresponding to the model. This solution is understood as improving a parallelism degree of the execution instruction sequences of the computation tasks to be executed by the threads in the executable program file, so that when the parallelism degree of the threads is not changed, the overall parallelism degree of the computation tasks is higher when the executable program is executed. The model compiling method in the embodiments is described in detail below.

During model compiling, after a high-level code language corresponding to the model to be compiled is sent to the CPU, the compiler in the CPU automatically generates, according to a preset rule, the computation graph corresponding to the model. A computation graph corresponding to any model includes multiple different computation sub-graphs. In some specific implementation processes, a process in which the compiler in the CPU determines an execution instruction sequence corresponding to any computation sub-graph is similar. In the embodiments, determining the execution instruction sequence corresponding to the computation sub-graph is described by using the target computation sub-graph as an example. The target computation sub-graph is any one of the multiple computation sub-graphs contained in the computation graph corresponding to the model to be compiled.

It should be noted that, in the embodiments, a sequence of generating the execution instruction sequences corresponding to the computation sub-graphs is not limited, and an execution instruction sequence corresponding to each computation sub-graph is separately generated.

In summary, when a compiling result (that is, the instruction execution sequence) corresponding to the target computation sub-graph is determined, a quantity of computation tasks corresponding to the target computation sub-graph is first determined. Next, multiple computation tasks to be separately executed by each thread are determined. Then the computation tasks allocated to each thread are grouped, and sequential rearrangement is performed on computation tasks in each group of computation tasks, to obtain an execution instruction sequence respectively corresponding to each group of rearranged computation tasks. Finally, the compiling result corresponding to the target computation sub-graph is determined based on the execution instruction sequence respectively corresponding to each group of computation tasks in each thread.

For details, the target computation sub-graph includes the multiple memory-access-intensive operators and the corresponding data. In the embodiments, a task for sequentially adopting the multiple memory-access-intensive operators to perform computation on the data is referred to as a computation task. For example, assuming that memory-access-intensive operators “+” and “−” exist in the target computation sub-graph, the data is three matrices: a matrix A, a matrix B, and a matrix C whose dimensions are all 8*8, and a computation logic is A+B−C, a quantity of tasks corresponding to the target computation sub-graph is 64, and the tasks include a computation task 1, a computation task 2, . . . , and a computation task 64.

Assuming that an executable program file obtained after the model to be compiled is compiled is executed by a GPU-i, in other words, the model to be compiled needs to be deployed on the GPU-i after being compiled. During compiling, the compiler in the CPU can obtain configuration information corresponding to the GPU-i, for example, a quantity of threads, a thread identifier, and a computation task parallelism degree of each thread in the GPU-i that is used for executing the computation task corresponding to the memory-access-intensive operator. The computation task parallelism degree of the thread is understood as a quantity of computation tasks that can be simultaneously executed by the thread. Multiple groups of computation tasks to be serially executed by the threads in the GPU-i are determined based on the configuration information of the GPU-i.

For example, depending on the foregoing assumption on the target computation sub-graph, in response to four threads being set in the GPU-i: a thread 1, a thread 2, a thread 3, and a thread 4, the 64 computation tasks corresponding to the target computation sub-graph are evenly allocated to the four threads. For example, the computation tasks 1 to 16 are allocated to the thread 1, the computation tasks 17 to 32 are allocated to the thread 2, the computation tasks 33 to 48 are allocated to the thread 3, and the computation tasks 49 to 64 are allocated to the thread 4. During actual application, the multiple computation tasks corresponding to the target computation sub-graph may alternatively be allocated to threads corresponding to the multiple computation tasks in the GPU-i in a non-even allocation manner.

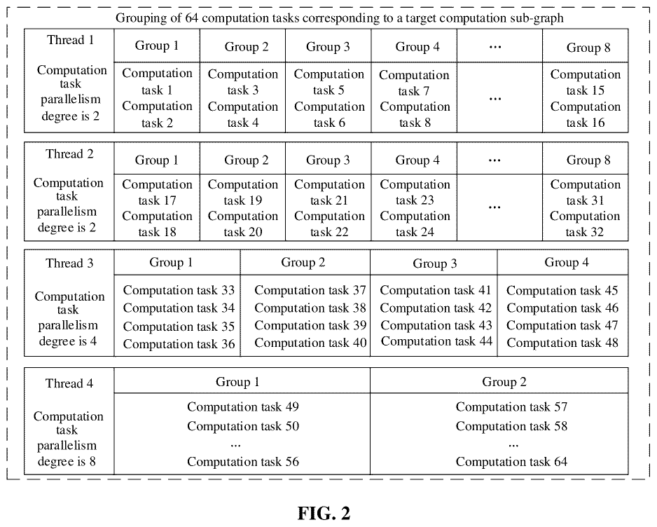

Then, for any one of the four threads (referred to as the target thread), 16 computation tasks in the target thread are grouped based on a computation task parallelism degree corresponding to the target thread. FIG. 2 is a schematic diagram of grouping of computation tasks according to some embodiments of the present disclosure. When a computation task parallelism degree of a thread 1 to a thread 4 is 2, an example in which the thread 1 and the thread 2 respectively need to execute 16 computation tasks is used for description. As shown in FIG. 2, computation tasks 1 to 16 to be executed by the thread 1 and computation tasks 17 to 32 to be executed by the thread 2 are both divided into eight groups, and each group of computation tasks includes two computation tasks. When the computation task parallelism degree of the thread 1 to the thread 4 is 4, an example in which the thread 3 needs to execute 16 computation tasks is used for description. As shown in FIG. 2, computation tasks 33 to 48 to be executed by the thread 3 are divided into four groups, and each group of computation tasks includes four computation tasks. When the computation task parallelism degree of the thread 1 to the thread 4 is 8, an example in which the thread 4 needs to execute 16 computation tasks is used for description. As shown in FIG. 2, computation tasks 49 to 64 to be executed by the thread 4 are divided into two groups, and each group of computation tasks includes eight computation tasks. It can be learned that, based on the grouping of computation tasks shown in FIG. 2, different computation task parallelism degrees correspond to different grouping results.

It should be noted that, in the embodiments, when the target thread executes multiple groups of computation tasks, the multiple groups of computation tasks are serially executed. When the target thread executes multiple computation tasks in the same group of computation tasks, the multiple computation tasks are executed in parallel. Serial execution means one group of computation tasks is executed first, and then a next group of computation tasks is executed. In-parallel execution means multiple computation tasks in the same group of computation tasks are executed simultaneously.

To implement efficient execution of the multiple computation tasks in the same group of computation tasks, in the embodiments, for a group of computation tasks, sequential rearrangement is performed on the multiple computation tasks based on the computational dependencies between the multiple memory-access-intensive operators. The computational dependency is understood as an execution sequence of memory-access-intensive operators and an association relationship of data corresponding to the memory-access-intensive operators. Taking A+B−C as an example, a memory-access-intensive operator “−” is executed after a memory-access-intensive operator “+”. When the memory-access-intensive operator “−” performs computation on C, the memory-access-intensive operator “−” depends on a computation result of “A+B”. Therefore, it is considered that there is a computational dependency between the memory-access-intensive operator “−” and the memory-access-intensive operator “+”.

It should be emphasized that in the embodiments, an objective of performing sequential rearrangement on the computation tasks is to enable different computation tasks corresponding to the same memory-access-intensive operator to be arranged in parallel. For example, assuming that there is a group of computation tasks in the thread 1, the group of computation tasks includes two computation tasks: a1+b1−c1 and a2+b2−c2, a computation result of a1+b1 is d1, and a computation result of a2+b2 is d2. When sequential rearrangement is performed on the two tasks, a computation task “a1+b1” and a computation task “a2+b2” that correspond to the memory-access-intensive operator “+” are arranged in parallel. A computation task “d1−c1” and a computation task “d2-c2” that correspond to the memory-access-intensive operator “−” are arranged in parallel.

For the two computation tasks in the thread 1, an execution instruction sequence generated after the rearrangement is “a compute instruction of a1+b1, a compute instruction of a2+b2, a compute instruction of d1−c1, and a compute instruction of d2−c2”. Since there is no computational dependency between a1+b1 and a2+b2, after the compute instruction of a1+b1 and the compute instruction of a2+b2 are continuously sent, both a1+b1 and a2+b2 can be executed, so that the instructions can be executed in parallel, thereby improving execution efficiency of the instructions.

It is understood that, in response to sequential rearrangement of computation tasks being not performed on the computation tasks a1+b1−c1 and a2+b2−c2, an execution instruction sequence corresponding to the computation tasks is “a compute instruction of a1+b1, a compute instruction of d1−c1, a compute instruction of a2+b2, and a compute instruction of d2−c2”. During actual execution, after the compute instruction of a1+b1 is sent, the compute instruction of d1−c1 can be continuously sent after d1 is obtained, and then the compute instruction of a1+b1 and the compute instruction of d1−c1 are similarly sent. This manner may cause time intervals between compute instructions. For example, after the compute instruction of a1+b1 is sent, a time interval of d1 is obtained while waiting for computation of a1+b1 to be completed. Consequently, on-chip storage resources of the GPU-i cannot be fully used, causing resource waste and low computation efficiency.

From a perspective of an overall parallelism degree of the computation tasks when the executable program file is executed, the thread 1 whose computation task parallelism degree is 2 may execute two computation tasks in parallel. In response to computation task parallelism degrees corresponding to the four threads in the GPU-i being 2, and the GPU-i executing the executable program, the overall parallelism degree of the computation tasks is 2*4=8. Compared with an original case in which the overall parallelism of the computation tasks corresponding to the four threads is 4, when execution instruction sequences that are generated based on groups of computation tasks and that are obtained in the method in the embodiments are executed, compute instructions corresponding to the same memory-access-intensive operator can be executed in parallel, and the overall parallelism degree of the computation tasks is effectively increased, thereby improving execution efficiency of the compute instructions.

Finally, the executable program file of the execution model of the executor is determined based on the execution instruction sequence both corresponding to the target thread and the any group of computation tasks, where the executable program file includes the execution instruction sequences respectively corresponding to the multiple computation sub-graphs contained in the computation graph.

In the embodiments, different computation tasks that correspond to the same memory-access-intensive operator in each group of computation tasks and that a thread needs to execute are arranged in parallel, so that an obtained execution instruction sequence has a high instruction parallelism degree. When the finally generated executable program file is executed, multiple execution instructions can be sent and executed in parallel, to simultaneously perform parallel computation on the different computation tasks corresponding to the same memory-access-intensive operator, thereby improving running efficiency of the executable program file when a quantity of threads in the executor remains unchanged.

In the foregoing embodiment, from the perspective of the computation task parallelism degree, a model compiling solution for improving running efficiency of the executable program file is provided. During actual application, factors affecting the running efficiency of the executable program file further include: resource scheduling during execution of instructions, scheduling overheads of the instructions, and the like. The following embodiments provide other model compiling solutions by considering these factors.

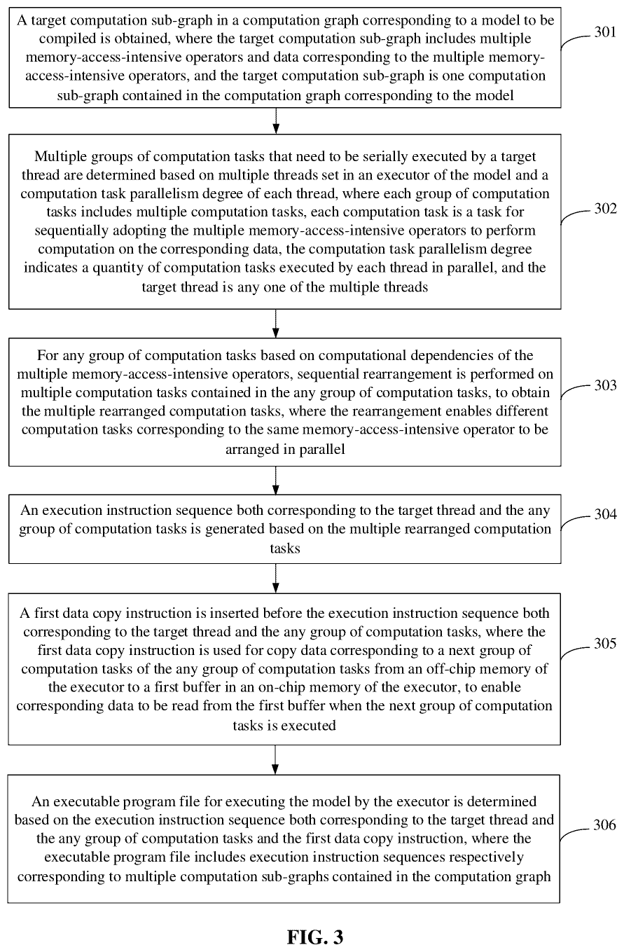

FIG. 3 is a flowchart of another model compiling method according to some embodiments of the present disclosure. As shown in FIG. 3, the method includes the following steps.

In step 301, a target computation sub-graph in a computation graph corresponding to a model to be compiled is obtained, where the target computation sub-graph includes multiple memory-access-intensive operators and data corresponding to the multiple memory-access-intensive operators, and the target computation sub-graph is one computation sub-graph contained in the computation graph corresponding to the model.

In step 302, multiple groups of computation tasks that need to be serially executed by a target thread are determined based on multiple threads set in an executor of the model and a computation task parallelism degree of each thread, where each group of computation tasks includes multiple computation tasks, each computation task is a task for sequentially adopting the multiple memory-access-intensive operators to perform computation on the corresponding data, the computation task parallelism degree indicates a quantity of computation tasks executed by each thread in parallel, and the target thread is any one of the multiple threads.

In step 303, for any group of computation tasks based on computational dependencies of the multiple memory-access-intensive operators, sequential rearrangement is performed on multiple computation tasks contained in the any group of computation tasks, to obtain the multiple rearranged computation tasks, where the rearrangement enables different computation tasks corresponding to the same memory-access-intensive operator to be arranged in parallel. In step 304, an execution instruction sequence both corresponding to the target thread and the any group of computation tasks is generated based on the multiple rearranged computation tasks.

In step 305, a first data copy instruction is inserted before the execution instruction sequence both corresponding to the target thread and the any group of computation tasks, where the first data copy instruction is used for copy data corresponding to a next group of computation tasks of the any group of computation tasks from an off-chip memory of the executor to a first buffer in an on-chip memory of the executor, to enable corresponding data to be read from the first buffer when the next group of computation tasks is executed.

In step 306, an executable program file for executing the model by the executor is determined based on the execution instruction sequence both corresponding to the target thread and the any group of computation tasks and the first data copy instruction, where the executable program file includes execution instruction sequences respectively corresponding to multiple computation sub-graphs contained in the computation graph.

For a specific implementation process of step 301 to step 304, refer to the foregoing embodiment, and details are not described in the embodiments again.

In the embodiments, an example in which the executor is a GPU is still used for description. During actual application, a memory in the GPU is divided into the on-chip memory and the off-chip memory. The on-chip memory includes a shared memory and a register, and is an on-chip memory that can be shared in a thread block. The off-chip memory corresponds to a global memory (or referred to as a main memory) of the GPU, and is visible to a global thread.

In the executable program file corresponding to the model executed by the GPU, an execution instruction sequence corresponding to a group of computation tasks usually includes instructions related to “read-compute-write”. “Read” refers to reading data corresponding to the group of computation tasks from a buffer or a register in the on-chip memory. “Compute” refers to performing, based on the data read from the buffer, computation corresponding to a memory-access-intensive operator. “Write” refers to writing a computation result into the register in the on-chip memory.

Before executing an execution instruction sequence corresponding to any group of computation tasks, the GPU usually needs to first copy data corresponding to the any group of computation tasks from the off-chip memory to the buffer in the on-chip memory, to read the corresponding data from the buffer when executing the execution instruction sequence corresponding to the any group of computation tasks. During actual application, a data copy time period corresponding to each group of computation tasks affects execution efficiency of the execution instruction sequence corresponding to each group of computation tasks. In response to the copy time period being excessively long, the execution instruction sequence corresponding to the computation task can be executed after waiting for a long time.

In the embodiments, to improve running efficiency of the executable program file, a “double buffering” mechanism is introduced. Commonly speaking, two buffers are disposed in the on-chip memory of the GPU. The two buffers are disposed, so that when a current group of computation tasks in the target thread is executed, data corresponding to a next group of computation tasks can be pre-copied from the off-chip memory to the buffer in the on-chip memory, in other words, a data copy process corresponding to the next group of computation tasks is performed in advance. In this way, when the next group of computation tasks is executed, data corresponding to each group of computation tasks is directly read from the buffer in the on-chip memory, without waiting for the data corresponding to the next group of computation tasks to be copied from the off-chip memory to the buffer in the on-chip memory. Waiting time period for copying data related to a computation task to the on-chip memory can be saved based on double buffering configuration, so that running efficiency of an execution instruction is higher.

Generally, the target thread needs to serially execute the multiple groups of computation tasks, and divides the multiple groups of computation tasks into an initial execution task (which may also be referred to as an initial group of execution tasks) and a kth group of execution tasks based on an execution sequence corresponding to the multiple computation tasks, where k is an integer greater than 1.

When any group of other tasks in step 305 corresponds to the kth group of execution tasks, the first data copy instruction is directly inserted before an execution instruction sequence corresponding to the kth group of execution tasks. The first data copy instruction is used for copying data corresponding to a (k+1)th group of computation tasks from the off-chip memory of the GPU to the first buffer in the on-chip memory of the GPU, so that the corresponding data is read from the first buffer when the (k+1)th group of computation tasks is executed.

When any group of computation tasks in step 305 corresponds to the initial group of computation tasks, a second data copy instruction is inserted before the first data copy instruction. The second data copy instruction is used for copying data corresponding to the initial group of computation tasks from the off-chip memory of the GPU to a second buffer in the on-chip memory of the GPU.

It should be noted that in response to each group of computation tasks including multiple memory-access-intensive operators, and the data corresponding to each group of computation tasks being copied to the buffer in the on-chip memory, data related to the same memory-access-intensive operator in the same group of computation tasks is sequentially copied to the buffer in the on-chip memory based on the computational dependencies of the memory-access-intensive operators.

In some specific implementation processes, based on the first copy instruction, the data that corresponds to the (k+1)th group of computation tasks and that is copied to the first buffer is data corresponding to an initial memory-access-intensive operator in the (k+1)th group of computation tasks. Based on the second copy instruction, the data that corresponds to the initial group of computation tasks and that is copied to the second buffer is data corresponding to an initial memory-access-intensive operator in the initial group of computation tasks.

For data corresponding to a memory-access-intensive operator other than the initial memory-access-intensive operator, in some implementations, a copy instruction corresponding to the data is similar to a copy instruction of the initial memory-access-intensive operator, and is moved forward into an execution instruction sequence of a previous group of computation tasks, or is in an execution instruction sequence of a current group of computation tasks. This is not limited in the embodiments.

The following describes a relationship between a copy instruction and an execution instruction sequence of a group of computation tasks more clearly by using an example. In the example, for clearer expression, execution instruction sequences corresponding to the group of computation tasks are divided into a read instruction, a compute instruction, and a write instruction.

The thread 1 shown in FIG. 2 is taken as an example for description. As shown in FIG. 2, the thread 1 needs to serially execute computation tasks in a group 1 to a group 8. It is assumed that the group 1 includes two computation tasks: a1+b1−c1 and a2+b2−c2, the group 2 includes two computation tasks: a3+b3−c3 and a4+b4−c4, and the group 3 includes two computation tasks: a5+b5−c5 and a6+b6−c6. A computation result of a1+b1 is d1, a computation result of a2+b2 is d2, a computation result of a3+b3 is d3, a computation result of a4+b4 is d4, a computation result of a5+b5 is d5, and a computation result of a6+b6 is d6. By analogy, examples of two computation tasks contained in each of the group 4 to the group 8 are not described again.

It is assumed that the two buffers disposed in the on-chip memory of the GPU are respectively a buffer 0 and a buffer 1. When the “double buffering” mechanism is introduced, execution instruction sequences corresponding to the group 1, the group 2, and the group 3 in the thread 1 are respectively as follows.

The execution instruction sequence corresponding to the group 1 in the thread 1 includes: 1) a copy instruction for copying data al, data b1, data a2, and data b2 from the off-chip memory to the buffer 0; 2) a copy instruction for copying data a3, data b3, data a4, and data b4 from the off-chip memory to the buffer 1; 3) a read instruction for reading the data a1, the data b1,the data a2, and the data b2 from the buffer 0; 4) a compute instruction for computing a1+b 1, and a compute instruction for computing a2+b2; 5) a write instruction for writing the computation results d1 and d2 into the register; 6) a read instruction for reading the computation results d1 and d2 from the register; 7) a copy instruction for copying data cl and data c2 from the off-chip memory to the buffer 0; 8) a read instruction for reading c1 and c2 from the buffer 0; 9) a compute instruction for computing d1+c1, and a compute instruction for computing d2+c2; and 10) a write instruction for writing computation results into the off-chip memory.

After the execution instruction sequence corresponding to the group 1 in the thread 1 is executed, the buffer 0 is empty.

The execution instruction sequence corresponding to the group 2 in the thread 1 includes: 1) a copy instruction for copying data a5, data b5, data a6, and data b6 from the off-chip memory to the buffer 0; 2) a read instruction for reading the data a3, the data b3, the data a4, and the data b4 from the buffer 1; 3) a compute instruction for computing a3+b3, and a compute instruction for computing a4+b4; 4) a write instruction for writing the computation results d3 and d4 into the register; 5) a read instruction for reading the computation results d3 and d4 from the register; 6) a copy instruction for copying data c3 and data c4 from the off-chip memory to the buffer 1; 7) a read instruction for reading c3 and c4 from the buffer 1; 8) a compute instruction for computing d3+c3, and a compute instruction for computing d4+c4; and 9) a write instruction for writing computation results into the off-chip memory.

After the execution instruction sequence corresponding to the group 2 in the thread 1 is executed, the buffer 1 is empty.

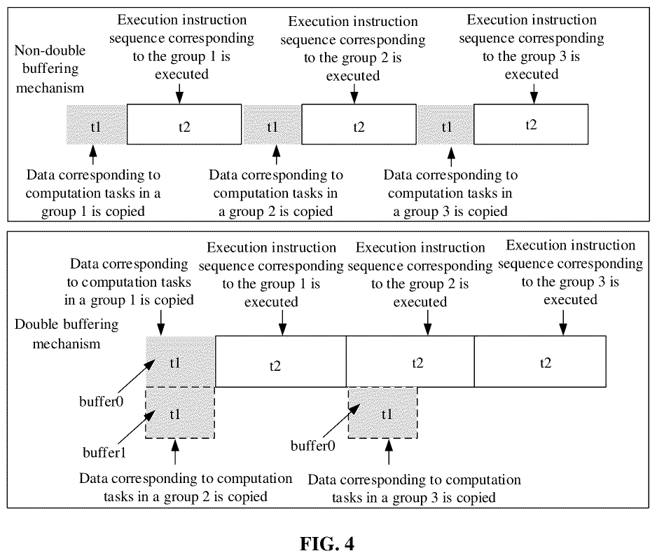

Execution instruction sequences corresponding to the group 3 to the group 7 in the thread 1 are similar to the execution instruction sequence corresponding to the group 2, and details are not described herein again. Since there is no next group after the group 8, an execution instruction sequence corresponding to the group 8 does not include a copy instruction for copying data corresponding to an initial memory-access-intensive operator in the next group to the buffer. In addition, it is found according to the foregoing example that, the first buffer and the second buffer in the embodiments do not fixedly indicate a particular buffer, but are alternately updated. For example, the first buffer in the instruction sequence of the group 1 indicates the buffer 1, and the first buffer in the indication sequence of the group 2 indicates the buffer 0. Assuming that a time point of copying data corresponding to an initial memory-access-intensive operator in each group of computation tasks to be executed by the thread 1 from the off-chip memory to the buffer in the on-chip memory is t1, and an execution time point of an execution instruction sequence corresponding to each group of computation tasks is t2, FIG. 4 can more clearly reflect that the “double buffering” mechanism in the embodiments improves running efficiency of the executable program file corresponding to the model.

FIG. 4 is a schematic diagram of execution situations of execution instruction sequences according to some embodiments of the present disclosure. FIG. 4 shows a time period required for executing instruction sequences corresponding to three groups of computation tasks. As shown in FIG. 4, in a non-double buffering mechanism, since there is one buffer, data related to one group of computation tasks can be copied each time. Therefore, for a next group of computation tasks, data corresponding to the next group of computation tasks can be copied until execution of an execution instruction sequence of the previous group of computation tasks is completed and the buffer is idle. The time period required for completing execution of the instruction sequences corresponding to the three groups of computation tasks is 3*(t1+t2). However, in the double buffering mechanism, when data corresponding to computation tasks in a group 1 is copied, data corresponding to computation tasks in a group 2 is copied at the same time. When an execution instruction sequence corresponding to the group 2 is executed, data corresponding to computation tasks in a group 3 is copied at the same time. The time period required for completing execution of the instruction sequences corresponding to the three groups of computation tasks is t1+3*t2, which is apparently shorter than the execution time in the non-double mechanism.

Therefore, in the embodiments, by introducing the double buffering mechanism, computation of different groups of computation tasks and data copy from the off-chip memory to the on-chip memory can be overlapped, so that memory access efficiency of the memory-access-intensive operator is effectively improved, thereby improving running efficiency of the executable program file corresponding to the model.

FIG. 5 is a flowchart of still another model compiling method according to some embodiments of the present disclosure. As shown in FIG. 5, the method includes the following steps.

In step 501, a target computation sub-graph in a computation graph corresponding to a model to be compiled is obtained, where the target computation sub-graph includes multiple memory-access-intensive operators and data corresponding to the multiple memory-access-intensive operators, and the target computation sub-graph is one computation sub-graph contained in the computation graph corresponding to the model.

In step 502, multiple groups of computation tasks that need to be serially executed by a target thread are determined based on multiple threads set in an executor of the model and a computation task parallelism degree of each thread, where each group of computation tasks includes multiple computation tasks, each computation task is a task for sequentially adopting the multiple memory-access-intensive operators to perform computation on the corresponding data, the computation task parallelism degree indicates a quantity of computation tasks executed by each thread in parallel, and the target thread is any one of the multiple threads.

In step 503, for any group of computation tasks based on computational dependencies of the multiple memory-access-intensive operators, sequential rearrangement is performed on multiple computation tasks contained in the any group of computation tasks, to obtain the multiple rearranged computation tasks, where the rearrangement enables different computation tasks corresponding to the same memory-access-intensive operator to be arranged in parallel. In step 504, an execution instruction sequence both corresponding to the target thread and the any group of computation tasks is generated based on the multiple rearranged computation tasks.

In step 505: an execution instruction sequence corresponding to the target computation sub-graph is determined based on execution instruction sequences respectively corresponding to the multiple groups of computation tasks respectively executed by the multiple threads in the target computation sub-graph. The execution instruction sequences respectively corresponding to the multiple computation sub-graphs in the computation graph are fused to determine an executable program file of the model.

For a specific implementation process of step 501 to step 504, refer to the foregoing embodiment, and details are not described in the embodiments again.

In the embodiments, when the executable program file corresponding to the model is generated, first, an execution instruction sequence corresponding to each group of computation tasks is generated. Then, an execution instruction sequence corresponding to a thread is determined based on the execution instruction sequence corresponding to each group of computation tasks that needs to be executed by the thread. Next, an execution instruction sequence corresponding to a computation sub-graph is determined based on an execution instruction sequence of each thread corresponding to the computation sub-graph. Finally, execution instruction sequences of computation sub-graphs corresponding to the computation graph of the model are fused, to generate the executable program file of the model.

Usually, after the executable program file corresponding to the model is generated, the executable program file needs to be debugged, to obtain an executable program file with better running performance. It is understood that, in response to the executable program file being directly debugged, debugging complexity is exponential, and debugging cannot be completed within a time period, and the executable program file with better running performance cannot be determined.

Since computation sub-graphs are usually independent of each other, in the embodiments, the execution instruction sequences corresponding to the computation sub-graphs are used as a basic debugging unit of the executable program file. The execution instruction sequences corresponding to the computation sub-graphs are debugged respectively, to determine execution instruction sequences with better running performance corresponding to the computation sub-graphs. Finally, the execution instruction sequences with better running performance corresponding to the computation sub-graphs are fused into the executable program file.

In some specific implementation processes, a computation task parallelism degree of each thread is flexibly configured. Based on the descriptions in the foregoing embodiments, different computation task parallelism degrees indicate different computation task grouping results, and further, different execution instruction sequences are generated.

Therefore, in a debugging manner of an execution instruction sequence, multiple execution instruction sequences corresponding to the target computation sub-graph at multiple computation task parallelism degrees are first obtained. Then, a target execution instruction sequence corresponding to the target computation sub-graph is determined based on running performance of the executor when separately executing the multiple execution instruction sequences. Finally, target execution instruction sequences respectively corresponding to the multiple computation sub-graphs are fused, to determine the executable program file of the model.

The running performance of the executor when executing the multiple execution instruction sequences is measured by using the execution time period. For example, the multiple execution instruction sequences corresponding to the target computation sub-graph at the multiple computation task parallelism degrees are respectively: an execution instruction sequence 1 and an execution instruction sequence 2. The execution time period of executing the execution instruction sequence 1 by the executor is T1, and the execution time period of executing the execution instruction sequence 2 is T2. In response to T1>T2, it is determined that the execution instruction sequence 2 is the target execution instruction sequence corresponding to the target computation sub-graph.

In the embodiments, the execution instruction sequences corresponding to the computation sub-graphs are used as the basic debugging unit, and compared with all the execution instruction sequences corresponding to the executable program file, there are few execution instruction sequences to be tested by the executor each time. Therefore, a target execution instruction sequence corresponding to each computation sub-graph is determined in a short time period. In this way, not only a feasible program file with better running performance can be obtained, but also debugging efficiency can be improved.

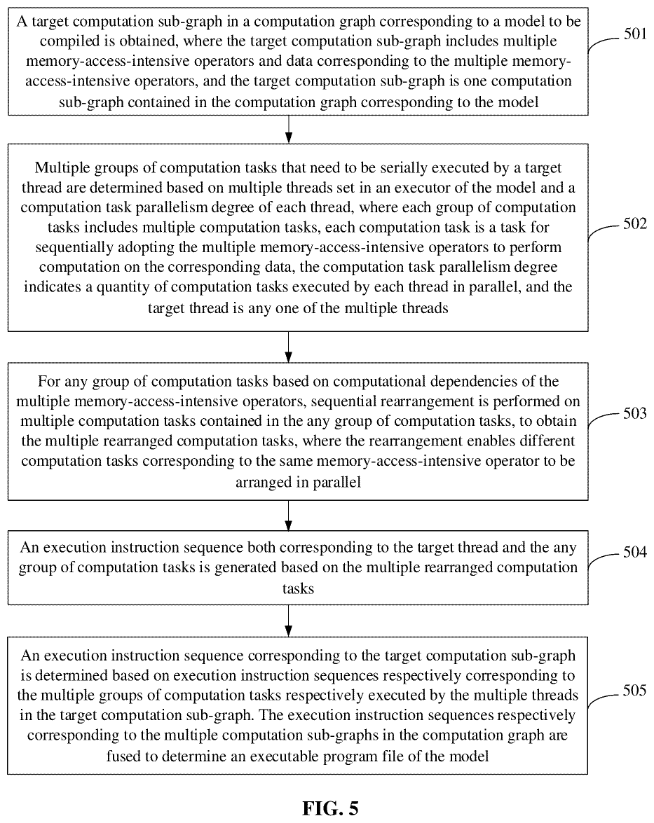

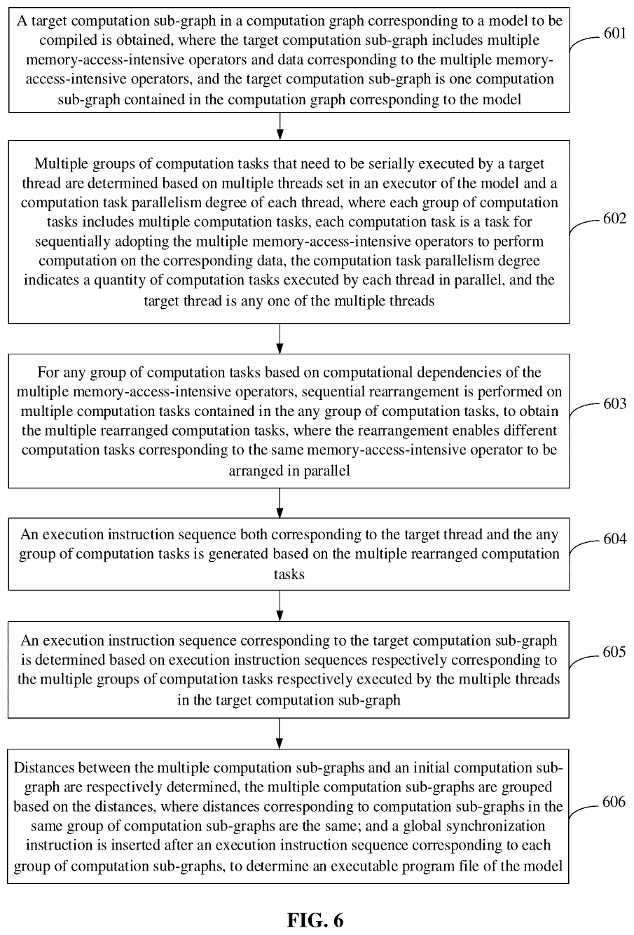

FIG. 6 is a flowchart of still another model compiling method according to some embodiments of the present disclosure. As shown in FIG. 6, the method includes the following steps.

In step 601, a target computation sub-graph in a computation graph corresponding to a model to be compiled is obtained, where the target computation sub-graph includes multiple memory-access-intensive operators and data corresponding to the multiple memory-access-intensive operators, and the target computation sub-graph is one computation sub-graph contained in the computation graph corresponding to the model.

In step 602, multiple groups of computation tasks that need to be serially executed by a target thread are determined based on multiple threads set in an executor of the model and a computation task parallelism degree of each thread, where each group of computation tasks includes multiple computation tasks, each computation task is a task for sequentially adopting the multiple memory-access-intensive operators to perform computation on the corresponding data, the computation task parallelism degree indicates a quantity of computation tasks executed by each thread in parallel, and the target thread is any one of the multiple threads.

In step 603, for any group of computation tasks based on computational dependencies of the multiple memory-access-intensive operators, sequential rearrangement is performed on multiple computation tasks contained in the any group of computation tasks, to obtain the multiple rearranged computation tasks, where the rearrangement enables different computation tasks corresponding to the same memory-access-intensive operator to be arranged in parallel. In step 604, an execution instruction sequence both corresponding to the target thread and the any group of computation tasks is generated based on the multiple rearranged computation tasks.

In step 605, an execution instruction sequence corresponding to the target computation sub-graph is determined based on execution instruction sequences respectively corresponding to the multiple groups of computation tasks respectively executed by the multiple threads in the target computation sub-graph.

In step 606, distances between the multiple computation sub-graphs and an initial computation sub-graph are respectively determined, the multiple computation sub-graphs are grouped based on the distances, where distances corresponding to computation sub-graphs in the same group of computation sub-graphs are the same; and a global synchronization instruction is inserted after an execution instruction sequence corresponding to each group of computation sub-graphs, to determine an executable program file of the model.

For a specific implementation process of step 601 to step 605, refer to the foregoing embodiment, and details are not described in the embodiments again.

Generally, after the execution instruction sequences corresponding to the computation sub-graphs are determined, the execution instruction sequences corresponding to the computation sub-graphs are separately stored in a form of a function, and the function may also be referred to as a GPU kernel. When a GPU executes the executable program file, actually, a CPU sends GPU kernels respectively corresponding to the computation sub-graphs to the GPU for execution.

In the foregoing manner of separately storing the GPU kernels corresponding to the computation sub-graphs, when the GPU executes the executable program file, the CPU not only needs to determine when to send a GPU kernel corresponding to a computation sub-graph, and which computation sub-graph the GPU kernel corresponds to, to the GPU for execution, but also needs to frequently schedule the GPU kernels corresponding to the computation sub-graphs, causing large non-computation overheads, that is, scheduling overheads. In addition, the computation sub-graphs respectively correspond to different GPU kernels, and specific additional overheads are further caused due to global synchronization brought by the GPU kernels. The global synchronization means that all execution instruction sequences corresponding to the GPU kernels are completely executed, and an on-chip memory does not need to be used. In addition, the CPU for processing a GPU task is usually in a busy state due to tasks such as data processing, and the executable program file corresponding to the model has a large quantity of GPU kernels to be separately executed. Consequently, the busy CPU cannot schedule these GPU kernels in time, resulting in a specific performance loss.

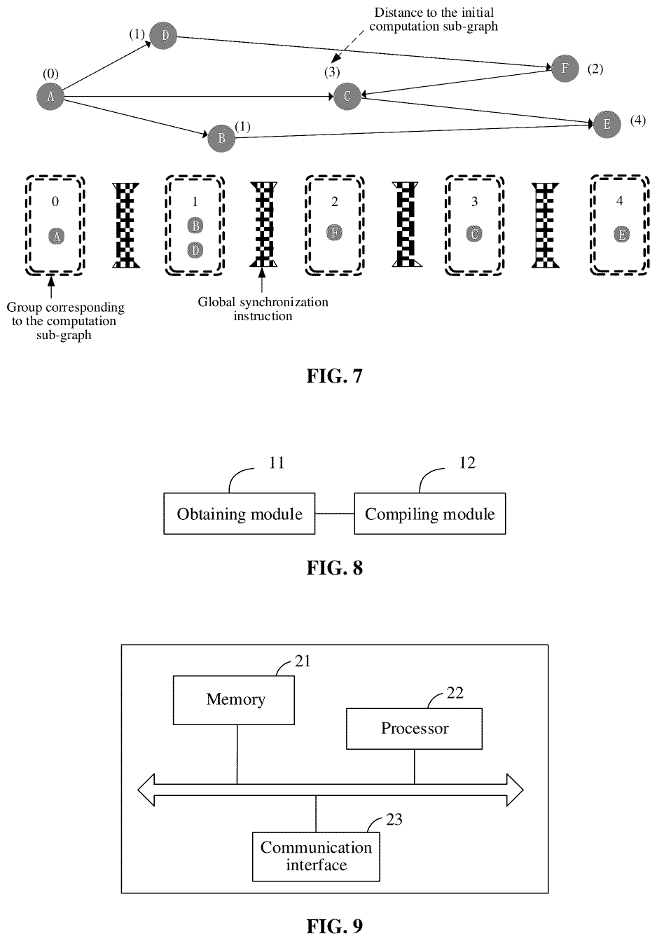

To solve at least one of the foregoing technical problems, in the embodiments, after the execution instruction sequences respectively corresponding to the multiple computation sub-graphs contained in the computation graph of the model are determined, the distances between the multiple computation sub-graphs and the initial computation sub-graph are first respectively determined. The initial computation sub-graph is a computation sub-graph corresponding to input data of the computation graph, that is, an initial computation sub-graph of the computation graph. Then, the multiple computation sub-graphs are grouped based on the distances, and computation sub-graphs having the same distance are grouped into the same group. Finally, the global synchronization instruction is inserted after the execution instruction sequence corresponding to each group of computation sub-graphs, to determine the executable program file of the model, where the executable program file of the model is a GPU kernel. FIG. 7 is a schematic diagram of computation sub-graphs according to some embodiments of the present disclosure. A process of determining an executable program file of a model in the embodiments is described by using an example with reference to FIG. 7. As shown in FIG. 7, it is assumed that a computation graph corresponding to a model to be compiled includes six computation sub-graphs, which are respectively a computation sub-graph A, a computation sub-graph B, a computation sub-graph C, a computation sub-graph D, a computation sub-graph E, and a computation sub-graph F (which are represented by A, B, C, D, E, and F in FIG. 7), and the computation sub-graph A is an initial computation sub-graph.

It can be learned from FIG. 7 that, there is at least one distance between one computation sub-graph and the initial computation sub-graph. Taking the computation sub-graph C as an example, when the computation sub-graph C follows a path of “A→C”, a corresponding distance to the initial computation sub-graph is 1. When the computation sub-graph C follows a path of “A→D→F→C”, a distance to the initial computation sub-graph is 3. For this case, in the embodiments, a distance between the computation sub-graph C and the initial computation sub-graph is determined to be 3.

Therefore, it is determined that, in FIG. 7, a distance between the computation sub-graph A and the initial computation sub-graph (that is, the computation sub-graph A), a distance between the computation sub-graph B and the initial computation sub-graph, the distance between the computation sub-graph C and the initial computation sub-graph, a distance between the computation sub-graph D and the initial computation sub-graph, a distance between the computation sub-graph E and the initial computation sub-graph, and a distance between the computation sub-graph F and the initial computation sub-graph are respectively: 0, 1, 3, 1, 4, and 2. Since the distance between the computation sub-graph B and the initial computation sub-graph and the distance between the computation sub-graph D and the initial computation sub-graph are both 1, the computation sub-graph B and the computation sub-graph D are grouped into one group, and the computation sub-graph A, the computation sub-graph C, the computation sub-graph E, and the computation sub-graph Fare separately grouped into one group.

Finally, a global synchronization instruction is inserted after execution instruction sequences corresponding to the five groups of computation sub-graphs, to determine the executable program file of the model. A group corresponding to the computation sub-graph E is used as a last group, and the global synchronization instruction is inserted optionally after an execution instruction sequence corresponding to the computation sub-graph E. Since the computation sub-graph B and the computation sub-graph D are in the same group, after the global synchronization instruction is inserted after grouping, it is equivalent to that global synchronization needs to be performed totally once for execution instruction execution sequences corresponding to the computation sub-graph B and the computation sub-graph D. However, in the foregoing case in which each computation sub-graph corresponds to one GPU kernel, global synchronization needs to be respectively performed for the execution instruction execution sequences corresponding to the computation sub-graph B and the computation sub-graph D. Therefore, the model compiling method in the embodiments can effectively reduce an amount of global synchronization, and a larger quantity of computation sub-graphs in the same group indicates a more evident effect.

In the embodiments, the executable program file of the model is one GPU kernel, to be specific, an execution instruction sequence corresponding to each group of computation sub-graphs and the global synchronization instruction are stored as one function. In this way, when the GPU needs to execute the executable program file of the model, the CPU needs to send one GPU kernel corresponding to the model to the GPU. The CPU does not need to determine when to send which GPU kernel to the GPU, and does not need to frequently schedule the GPU kernel, thereby effectively reducing non-computation overheads and performance losses generated when the CPU schedules the GPU kernel. In addition, since the computation sub-graphs are grouped, and the global synchronization instruction is inserted after each group, the amount of global synchronization can be reduced, and computation efficiency, that is, running efficiency of the executable program file, can be improved.

During actual application, the model compiling solutions in the foregoing embodiments are combined with each other, to achieve a better model compiling effect.

In addition, it should be noted that, in the model compiling method provided in the foregoing embodiments, although a process of generating an execution instruction of a computation task related to a memory-access-intensive operator is described, it does not mean that a complete executable program file corresponding to the model includes the execution instruction of the computation task related to the memory-access-intensive operator, and the complete executable program file corresponding to the model further includes an execution instruction of a computation task related to a compute-intensive operator.

The following describes a model compiling apparatus according to at least one embodiment of the present disclosure in detail. A person having ordinary skill in the art may understand that these apparatuses is constructed by using commercial hardware components and configured through steps taught in this solution.

FIG. 8 is a structural schematic diagram of a model compiling apparatus according to some embodiments of the present disclosure. As shown in FIG. 8, the apparatus includes: an obtaining module 11 and a compiling module 12.

The obtaining module 11 is configured to obtain a target computation sub-graph in a computation graph corresponding to a model to be compiled, where the target computation sub-graph includes multiple memory-access-intensive operators and data corresponding to the multiple memory-access-intensive operators, and the target computation sub-graph is one computation sub-graph contained in the computation graph.

The compiling module 12 is configured to: determine, based on multiple threads set in an executor of the model and a computation task parallelism degree of each thread, multiple groups of computation tasks to be serially executed by a target thread, where each group of computation tasks includes multiple computation tasks, each computation task is a task for sequentially adopting the multiple memory-access-intensive operators to perform computation on the corresponding data, the computation task parallelism degree indicates a quantity of computation tasks executed by each thread in parallel, and the target thread is any one of the multiple threads; perform, for any group of computation tasks based on computational dependencies of the multiple memory-access-intensive operators, sequential rearrangement on multiple computation tasks contained in the any group of computation tasks, to obtain the multiple rearranged computation tasks, where the rearrangement enables different computation tasks corresponding to the same memory-access-intensive operator to be arranged in parallel; generate, based on the multiple rearranged computation tasks, an execution instruction sequence both corresponding to the target thread and the any group of computation tasks; and determine, based on the execution instruction sequence both corresponding to the target thread and the any group of computation tasks, an executable program file for executing the model by the executor, where the executable program file includes execution instruction sequences respectively corresponding to multiple computation sub-graphs contained in the computation graph.

In some implementations, the compiling module 12 is further configured to insert a first data copy instruction before the execution instruction sequence both corresponding to the target thread and the any group of computation tasks, where the first data copy instruction is used for copying data corresponding to a next group of computation tasks of the any group of computation tasks from an off-chip memory of the executor to a first buffer in an on-chip memory of the executor, to enable the corresponding data to be read from the first buffer when the next group of computation tasks is executed.

In some implementations, the compiling module 12 is specifically configured to insert a second data copy instruction before the first data copy instruction in response to the any group of computation tasks being an initial computation task in the multiple groups of computation tasks, where the second data copy instruction is used for copying data corresponding to the any group of computation tasks from the off-chip memory of the executor to a second buffer in the on-chip memory of the executor.

The data, corresponding to the next group of computation tasks, copied to the first buffer is data corresponding to an initial memory-access-intensive operator in the next group of computation tasks. The data, corresponding to the any group of computation tasks, copied to the second buffer is data corresponding to an initial memory-access-intensive operator in the any group of computation tasks.

In some implementations, the compiling module 12 is further specifically configured to: determine, based on execution instruction sequences respectively corresponding to the multiple groups of computation tasks respectively executed by the multiple threads in the target computation sub-graph, an execution instruction sequence corresponding to the target computation sub-graph; and fuse the execution instruction sequences respectively corresponding to the multiple computation sub-graphs in the computation graph, to determine the executable program file of the model.

In some implementations, the compiling module 12 is further specifically configured to: obtain multiple execution instruction sequences corresponding to the target computation sub-graph at multiple computation task parallelism degrees; determine, based on running performance of the executor when separately executing the multiple execution instruction sequences, a target execution instruction sequence corresponding to the target computation sub-graph; and fuse target execution instruction sequences respectively corresponding to the multiple computation sub-graphs, to determine the executable program file of the model.

In some implementations, the compiling module 12 is further specifically configured to: respectively determine distances between the multiple computation sub-graphs and an initial computation sub-graph; group the multiple computation sub-graphs based on the distances, where distances corresponding to computation sub-graphs in the same group of computation sub-graphs are the same; and insert a global synchronization instruction after an execution instruction sequence corresponding to each group of computation sub-graphs, to determine the executable program file of the model.

In the model compiling solution provided in the embodiments of the present disclosure, execution instruction optimization compiling is performed on a computation task related to a memory-access-intensive operator in a computation sub-graph corresponding to the model. When the model to be compiled is compiled, the multiple computation sub-graphs contained in the computation graph corresponding to the model are respectively compiled. The computation sub-graphs is classified into two types. One type is a computation sub-graph corresponding to the memory-access-intensive operator, and one type is a computation sub-graph corresponding to a compute-intensive operator. In the embodiments of the present disclosure, compiling and optimization are performed on the computation sub-graph corresponding to the memory-access-intensive operator. Specifically, when the target computation sub-graph including the multiple memory-access-intensive operators and the corresponding data is compiled, the multiple computation tasks to be executed by each thread are determined based on the multiple threads set in the executor (such as a GPU) of the model and the computation task parallelism degree of each thread, the multiple computation tasks to be executed by each thread are grouped, and the multiple groups of computation tasks to be serially executed by any one of the multiple threads (referred to as the target thread) are determined, where each group of computation tasks includes the multiple computation tasks, and each computation task is a task for sequentially adopting the multiple memory-access-intensive operators to perform computation on the corresponding data, and the computation task parallelism degree indicates a quantity of computation tasks executed by each thread in parallel. Subsequently, for the any group of computation tasks in the target thread based on the computational dependencies of the multiple memory-access-intensive operators, the sequential rearrangement is performed on the multiple computation tasks contained in the any group of computation tasks, to obtain the multiple rearranged computation tasks, and the execution instruction sequence both corresponding to the target thread and the any group of computation tasks is generated based on the multiple rearranged computation tasks, where the rearrangement is to enable different computation tasks corresponding to the same memory-access-intensive operator to be arranged in parallel. Finally, the executable program file for executing the model by the executor is determined based on the execution instruction sequence both corresponding to the target thread and the any group of computation tasks. The executable program file includes the execution instruction sequences respectively corresponding to the multiple computation sub-graphs contained in the computation graph. In other words, the executable program file includes a complete execution instruction of the model, and the executable program file needs to be provided for the executor once.

In the embodiments, different computation tasks that correspond to the same memory-access-intensive operator in each group of computation tasks and that a thread needs to execute are arranged in parallel, so that an obtained execution instruction sequence has a high instruction parallelism degree. When a finally generated executable program file is executed, multiple execution instructions can be sent and executed in parallel, to simultaneously perform parallel computation on the different computation tasks corresponding to the same memory-access-intensive operator, thereby improving running efficiency of the executable program file when a quantity of threads in the executor remains unchanged, and fully using resources of the executor.

The communication apparatus shown in FIG. 8 may perform steps performed by the communication system in the foregoing embodiments. For a part that is not described in detail in the embodiments, refer to related descriptions in the foregoing embodiments, and details are not described herein again.

In a possible design, the structure of the two-dimensional code recognition apparatus shown in FIG. 8 is implemented as an electronic device. As shown in FIG. 9, the electronic device includes: a memory 21, a processor 22, and a communication interface 23. The memory 21 stores executable code. When the executable code is executed by the processor 22, the processor 22 is enabled to implement at least the model compiling method provided in the foregoing embodiments.

In addition, some embodiments of the present disclosure provide a non-transitory machine-readable storage medium. The non-transitory machine-readable storage medium stores executable code, and when the executable code is executed by a processor of an electronic device, the processor is enabled to implement at least the model compiling method provided in the foregoing embodiments.

The described apparatus embodiments are examples. Network units described as separate parts may or may not be physically separated. Some or all of the modules are selected according to actual needs to achieve the objectives of the solutions of embodiments. A person having ordinary skill in the art may understand and implement embodiments without creative efforts. Through the descriptions of the foregoing implementations, a person having ordinary skill in the art can clearly understand that each implementation can be implemented by using a necessary general hardware platform, and certainly, can alternatively be implemented by a combination of hardware and software. Based on such understanding, the essence of the foregoing technical solutions or the part contributing to a conventional technology can be embodied in a form of a computer product. The present disclosure may use a form of a computer program product that is implemented on at least one computer-idle storage medium (including but not limited to a magnetic disk storage, a CD-ROM, an optical memory, and the like) that include computer-idle program code.

Finally, it should be noted that, the foregoing embodiments are intended for describing the technical solutions of the present disclosure, but not for limiting the present disclosure. Although the present disclosure is described in detail with reference to the foregoing embodiments, a person having ordinary skill in the art should understand that modifications may still be made to the technical solutions described in the foregoing embodiments, or equivalent replacements are made to the part of the technical features; and such modifications or replacements do not cause the essence of corresponding technical solutions to depart from the spirit and scope of the technical solutions in embodiments of the present disclosure.

1. A model compiling method, comprising:
obtaining a target computation sub-graph in a computation graph corresponding to a model to be compiled, wherein the target computation sub-graph comprises a plurality of memory-access-intensive operators and data corresponding to the plurality of memory-access-intensive operators, and the target computation sub-graph is one computation sub-graph contained in the computation graph;
determining, based on a plurality of threads set in an executor of the model and a computation task parallelism degree of each thread, a plurality of groups of computation tasks to be serially executed by a target thread, wherein each group of computation tasks comprises a plurality of computation tasks, each computation task is a task for sequentially adopting the plurality of memory-access-intensive operators to perform computation on the data, the computation task parallelism degree indicates a quantity of computation tasks executed by each thread in parallel, and the target thread is any one of the plurality of threads;
performing, for any group of computation tasks based on computational dependencies of the plurality of memory-access-intensive operators, sequential rearrangement on a plurality of computation tasks contained in the any group of computation tasks, to obtain the plurality of rearranged computation tasks, wherein the rearrangement enables different computation tasks corresponding to the same memory-access-intensive operator to be arranged in parallel;
generating, based on the plurality of rearranged computation tasks, an execution instruction sequence both corresponding to the target thread and the any group of computation tasks; and
determining, based on the execution instruction sequence both corresponding to the target thread and the any group of computation tasks, an executable program file for executing the model by the executor, wherein the executable program file comprises execution instruction sequences respectively corresponding to a plurality of computation sub-graphs contained in the computation graph.

2. The model compiling method according to claim 1, wherein the model compiling method further comprises:
inserting a first data copy instruction before the execution instruction sequence both corresponding to the target thread and the any group of computation tasks, wherein the first data copy instruction is used for copying data corresponding to a next group of computation tasks of the any group of computation tasks from an off-chip memory of the executor to a first buffer in an on-chip memory of the executor, to enable the data to be read from the first buffer when the next group of computation tasks is executed.

3. The model compiling method according to claim 2, wherein the model compiling method further comprises:
inserting a second data copy instruction before the first data copy instruction in response to the any group of computation tasks being an initial computation task in the plurality of groups of computation tasks, wherein the second data copy instruction is used for copying data corresponding to the any group of computation tasks from the off-chip memory of the executor to a second buffer in the on-chip memory of the executor.

4. The model compiling method according to claim 3, wherein the data, corresponding to the next group of computation tasks, copied to the first buffer is data corresponding to an initial memory-access-intensive operator in the next group of computation tasks; and the data, corresponding to the any group of computation tasks, copied to the second buffer is data corresponding to an initial memory-access-intensive operator in the any group of computation tasks.

5. The model compiling method according to-any claim wherein determining, based on the execution instruction sequence both corresponding to the target thread and the any group of computation tasks, the executable program file for executing the model by the executor comprises:
determining, based on execution instruction sequences respectively corresponding to the plurality of groups of computation tasks respectively executed by the plurality of threads in the target computation sub-graph, an execution instruction sequence corresponding to the target computation sub-graph; and
fusing the execution instruction sequences respectively corresponding to the plurality of computation sub-graphs in the computation graph, to determine the executable program file of the model.

6. The model compiling method according to claim 5, wherein the model compiling method further comprises:
obtaining a plurality of execution instruction sequences corresponding to the target computation sub-graph at a plurality of computation task parallelism degrees; and
determining, based on running performance of the executor when separately executing the plurality of execution instruction sequences, a target execution instruction sequence corresponding to the target computation sub-graph; and
fusing the execution instruction sequences respectively corresponding to the plurality of computation sub-graphs in the computation graph, to determine the executable program file of the model comprises:
fusing target execution instruction sequences respectively corresponding to the plurality of computation sub-graphs, to determine the executable program file of the model.

7. The model compiling method according to claim 5, wherein fusing the execution instruction sequences respectively corresponding to the plurality of computation sub-graphs in the computation graph, to determine the executable program file of the model comprises:
respectively determining distances between the plurality of computation sub-graphs and an initial computation sub-graph;
grouping the plurality of computation sub-graphs based on the distances, wherein distances corresponding to computation sub-graphs in the same group of computation sub-graphs are the same; and
inserting a global synchronization instruction after an execution instruction sequence corresponding to each group of computation sub-graphs, to determine the executable program file of the model.

8. (canceled)

9. An electronic device, comprising: a memory, a processor, and a communication interface, wherein the memory stores executable code, and when the executable code is executed by the processor, the processor is enabled to perform the following steps:
obtaining a target computation sub-graph in a computation graph corresponding to a model to be compiled, wherein the target computation sub-graph comprises a plurality of memory-access-intensive operators and data corresponding to the plurality of memory-access-intensive operators, and the target computation sub-graph is one computation sub-graph contained in the computation graph;
determining, based on a plurality of threads set in an executor of the model and a computation task parallelism degree of each thread, a plurality of groups of computation tasks to be serially executed by a target thread, wherein each group of computation tasks comprises a plurality of computation tasks, each computation task is a task for sequentially adopting the plurality of memory-access-intensive operators to perform computation on the data, the computation task parallelism degree indicates a quantity of computation tasks executed by each thread in parallel, and the target thread is any one of the plurality of threads;
performing, for any group of computation tasks based on computational dependencies of the plurality of memory-access-intensive operators, sequential rearrangement on a plurality of computation tasks contained in the any group of computation tasks, to obtain the plurality of rearranged computation tasks, wherein the rearrangement enables different computation tasks corresponding to the same memory-access-intensive operator to be arranged in parallel;
generating, based on the plurality of rearranged computation tasks, an execution instruction sequence both corresponding to the target thread and the any group of computation tasks; and
determining, based on the execution instruction sequence both corresponding to the target thread and the any group of computation tasks, an executable program file for executing the model by the executor, wherein the executable program file comprises execution instruction sequences respectively corresponding to a plurality of computation sub-graphs contained in the computation graph.

10. A non-transitory storage medium, wherein the non-transitory machine-readable storage medium stores executable code, and when the executable code is executed by a processor of an electronic device, the processor is enabled to perform the following steps:
obtaining a target computation sub-graph in a computation graph corresponding to a model to be compiled, wherein the target computation sub-graph comprises a plurality of memory-access-intensive operators and data corresponding to the plurality of memory-access-intensive operators, and the target computation sub-graph is one computation sub-graph contained in the computation graph;
determining, based on a plurality of threads set in an executor of the model and a computation task parallelism degree of each thread, a plurality of groups of computation tasks to be serially executed by a target thread, wherein each group of computation tasks comprises a plurality of computation tasks, each computation task is a task for sequentially adopting the plurality of memory-access-intensive operators to perform computation on the data, the computation task parallelism degree indicates a quantity of computation tasks executed by each thread in parallel, and the target thread is any one of the plurality of threads;
performing, for any group of computation tasks based on computational dependencies of the plurality of memory-access-intensive operators, sequential rearrangement on a plurality of computation tasks contained in the any group of computation tasks, to obtain the plurality of rearranged computation tasks, wherein the rearrangement enables different computation tasks corresponding to the same memory-access-intensive operator to be arranged in parallel;
generating, based on the plurality of rearranged computation tasks, an execution instruction sequence both corresponding to the target thread and the any group of computation tasks; and
determining, based on the execution instruction sequence both corresponding to the target thread and the any group of computation tasks, an executable program file for executing the model by the executor, wherein the executable program file comprises execution instruction sequences respectively corresponding to a plurality of computation sub-graphs contained in the computation graph.

11. The model compiling method according to claim 2, wherein determining, based on the execution instruction sequence both corresponding to the target thread and the any group of computation tasks, the executable program file for executing the model by the executor comprises:
determining, based on execution instruction sequences respectively corresponding to the plurality of groups of computation tasks respectively executed by the plurality of threads in the target computation sub-graph, an execution instruction sequence corresponding to the target computation sub-graph; and
fusing the execution instruction sequences respectively corresponding to the plurality of computation sub-graphs in the computation graph, to determine the executable program file of the model.

12. The model compiling method according to claim 3, wherein determining, based on the execution instruction sequence both corresponding to the target thread and the any group of computation tasks, the executable program file for executing the model by the executor comprises:
determining, based on execution instruction sequences respectively corresponding to the plurality of groups of computation tasks respectively executed by the plurality of threads in the target computation sub-graph, an execution instruction sequence corresponding to the target computation sub-graph; and
fusing the execution instruction sequences respectively corresponding to the plurality of computation sub-graphs in the computation graph, to determine the executable program file of the model.

13. The model compiling method according to claim 4, wherein determining, based on the execution instruction sequence both corresponding to the target thread and the any group of computation tasks, the executable program file for executing the model by the executor comprises:
determining, based on execution instruction sequences respectively corresponding to the plurality of groups of computation tasks respectively executed by the plurality of threads in the target computation sub-graph, an execution instruction sequence corresponding to the target computation sub-graph; and
fusing the execution instruction sequences respectively corresponding to the plurality of computation sub-graphs in the computation graph, to determine the executable program file of the model.

14. The model compiling method according to claim 1, wherein the model compiling method further comprises:
determining, based on the plurality of memory-access-intensive operators and data corresponding to the plurality of memory-access-intensive operators comprised in the target computation sub-graph, a quantity of computation tasks corresponding to the target computation sub-graph.

15. The model compiling method according to claim 14, wherein determining, based on the plurality of threads set in the executor of the model and the computation task parallelism degree of each thread, the plurality of groups of computation tasks to be serially executed by the target thread comprises:
determining, based on the plurality of threads set in the executor of the model and the quantity of computation tasks corresponding to the target computation sub-graph, computation tasks corresponding to each thread; and
determining, based on the computation tasks corresponding to each thread and the computation task parallelism degree of each thread, the plurality of groups of computation tasks to be serially executed by the target thread.

16. The model compiling method according to claim 15, wherein determining, based on the plurality of threads set in the executor of the model and the quantity of computation tasks corresponding to the target computation sub-graph, the computation tasks corresponding to each thread comprises:
determining the computation tasks corresponding to each thread based on the plurality of threads set in the executor of the model, the quantity of computation tasks corresponding to the target computation sub-graph and a preset allocation strategy, wherein the preset allocation strategy comprises a non-even allocation manner and an even allocation manner.

17. The model compiling method according to claim 1, wherein the computational dependency is used for representing an execution sequence of the plurality of memory-access-intensive operators and an association relationship of data corresponding to the plurality of memory-access-intensive operators.

18. The model compiling method according to claim 3, wherein the first buffer and the second buffer are alternately updated.

19. The model compiling method according to claim 6, wherein the running performance of the executor when executing the plurality of execution instruction sequences is measured by using an execution time period.

20. The model compiling method according to claim 7, wherein the initial computation sub-graph is a computation sub-graph corresponding to input data of the computation graph.

21. The model compiling method according to claim 1, wherein the executable program file corresponding to the model further comprises execution instructions of a computation task related to a compute-intensive operator.
